(19) United States
(12) Patent Application Publication
(10) Pub. No.: US 2010/0166187 A1
(43) Pub. Date: Jul. 1, 2010

(54) QKD USING HIGH-ALTITUDE PALTFORMS

(76) Inventors: Alexei Trifonov, Boston, MA (US); Gelfond Robert, New York, NY (US)

Correspondence Address: OPTICUS IP LAW, PLLC, 7791 ALISTER MACKENZIE DRIVE, SARASOTA, FL, 34240, US

(21) Appl. No.: 12/310,251

(22) PCT Filed: Sep. 7, 2007
(86) PCT No.: PCT/US07/19600

§ 371 Date: Feb. 19, 2009

Related U.S. Application Data
(60) Provisional application No. 60/843,640, filed on Sep. 11, 2006.

(51) Int. Cl. H04L 9/08

(52) U.S. Cl. 380/279

(57) ABSTRACT

Systems and methods for performing quantum key distribution (QKD) using one or more high-altitude platforms (HAPs) are disclosed. The system includes a second QKD station (Alice) supported by the HAP so as to be in free-space communication with the first QKD station (Bob) over an optical path (OP) via an optical quantum communication channel that carries quantum signals (P1′), an optical synchronization channel that carries synchronization signals (PS) and optionally classical communication signals (PC), an optical beacon channel that carries beacon signals (PB), and a radio-frequency (RF) channel that carries RF signals. The beacon signals are used to detect changes in the optical path and correct the synchronization signals (PB) so as to gate the first and second SPD pairs to correspond to arrival times of the quantum signals at said first and second SPD pairs. The system does not require a Pockels cell for quantum signal modulation, thereby improving the security of the system.

### CLAIM OF PRIORITY

This application claims priority from U.S. Provisional Patent Application No. 60/843,640, filed on Sep. 11, 2006.

### TECHNICAL FIELD OF THE INVENTION

The present invention relates to quantum cryptography, and in particular relates to quantum key distribution (QKD) systems that use high-altitude platforms.

### BACKGROUND ART

QKD involves establishing a key between a sender (“Alice”) and a receiver (“Bob”) by using either single-photons or weak (e.g., 0.1 photon on average) optical signals (pulses) called “qubits” or “quantum signals” transmitted over a “quantum channel.” Unlike classical cryptography whose security depends on computational impracticality, the security of quantum cryptography is based on the quantum mechanical principle that any measurement of a quantum system in an unknown state will modify its state. Consequently, an eavesdropper (“Eve”) that attempts to intercept or otherwise measure the exchanged qubits introduces errors that reveal her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). Specific QKD systems are described in U.S. Pat. No. 5,307,410 to Bennett, and in the article by C. H. Bennett entitled “Quantum Cryptography Using Any Two Non-Orthogonal States”, Phys. Rev. Lett. 68 3121 (1992). The general process for performing QKD is described in the book by Bouwmeester et al., “The Physics of Quantum Information,” Springer-Verlag 2001, in Section 2.3, pages 27-33.

U.S. Pat. No. 5,966,224 to Hughes et al. (“the '224 patent”), which patent is incorporated by reference herein, discloses a Pockels-cell-based optical system for providing secure communications between an earth station and a low-orbit spacecraft. The optical system of the '224 patent enables secure long-range communication through space to provides secure satellite-based telemetry using the principles of QKD.

Satellite-based QKD presents serious technical challenges. For instance, the ground-satellite link is normally in the range from 100-400 km. The faint quantum signal encounters turbulence, weather and scattering from airborne particles, particularly over the 10-20 km closest to the ground. These factors result in ˜30-50 dB loss. Accordingly, the system of the '224 patent would require quantum signals having a relatively high average number of photons per pulse in order to have a reasonable data rate. This leads to a decrease in the overall security of the system. Further, use of a Pockels cell for quantum signal modulation presents a security risk because they have a pronounced electromagnetic interference (EMI) signature that could be detected by an eavesdropper and used to discern the quantum signal modulations.

### BRIEF DESCRIPTION OF THE INVENTION

The present invention includes systems and methods for performing QKD using one or more high-altitude platforms (HAPs). The system includes a second QKD station supported by the HAP so as to be in free-space communication with the first QKD station over an optical path via an optical quantum communication channel that carries quantum signals, an optical synchronization channel that carries synchronization signals, an optical beacon channel that carries beacon signals, and a radio-frequency (RF) channel that carries RF signals. The beacon signals are used to detect changes in the optical path and correct the synchronization signals so as to gate the first and second SPD pairs to correspond to arrival times of the quantum signals at said first and second SPD pairs. The system does not require a Pockels cell for quantum signal modulation, thereby improving the security of the system over prior art systems.

### BRIEF DESCRIPTION OF THE DRAWINGS

FIG. 1 is a schematic diagram of an example embodiment of a QKD station ALICE suitable for use in a HAP QKD configuration;

FIG. 2 is a schematic diagram of an example embodiment of a QKD station BOB suitable for use in combination with QKD station ALICE described immediately above and shown in FIG. 1, for use in a HAP configuration;

FIG. 3 is a schematic diagram of an example embodiment of a HAP-based QKD system that employs a HAP in the form of a zeppelin;

FIG. 4 is a schematic diagram illustrating a second example embodiment of a HAP-based QKD system used to transfer quantum keys between QKD stations ALICE, BOB-1 and BOB-2, wherein BOB-1 and BOB-2 at different locations L1 and L2 and ALICE resides in the HAP;

FIG. 5 is a schematic diagram of a third example embodiment of HAP-based QKD system wherein HAP 300 includes both ALICE and BOB QKD stations;

FIG. 6 is a schematic diagram of a fourth example embodiment of a HAP-based QKD system that employs entangled photons to perform QKD; and

FIG. 7 is a schematic diagram of a fifth example embodiment of a HAP-based QKD system that involves a spacecraft that includes a QKD station BOB, wherein the QKD system allows for a common key to be provided to a ground based QKD station and a space-based QKD station.

The various elements depicted in the drawing are merely representational and are not necessarily drawn to scale. Certain sections thereof may be exaggerated, while others may be minimized. The drawing is intended to illustrate an example embodiment of the invention that can be understood and appropriately carried out by those of ordinary skill in the art.

### DETAILED DESCRIPTION OF THE INVENTION

The present invention is directed to QKD systems and methods that employ high-altitude platforms (HAPs). An example embodiment of QKD stations ALICE and BOB suitable for use with HAPs is first described, follow by several different example embodiments of HAP-based QKD systems that employ ALICE and BOB.

### ALICE

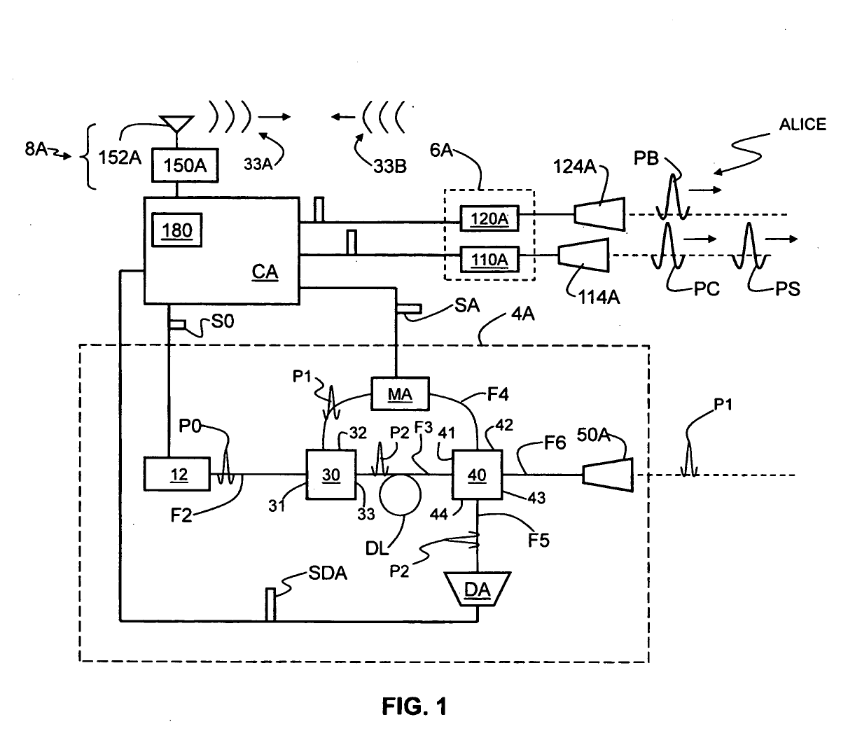

FIG. 1 is a schematic diagram of an example embodiment of a QKD station ALICE. ALICE includes quantum optics communication layer 4A, and a classical optics communication layer 6A and a radio-frequency (RF) communications layer 8A, all operably coupled to a controller CA.

Quantum optics layer 4A includes a laser unit 12 optically coupled to a beam splitter 30 that has an input port (face) 31 and output faces 32 and 33. Beam splitter 30 is optically coupled to laser unit 12 via an optical fiber section F2 optically coupled to input face 31. Beam splitter 30 in turn is optically coupled to another beam splitter 40 that has two input faces 41 and 42 and two output faces 43 and 44. Beam splitter 40 is optically coupled to beam splitter 30 via an optical fiber section F3 optically coupled to output face 33 and input face 41. Optical fiber section F3 includes a delay line DL.

Beam splitters 30 and 40 are also optically coupled to one another via an optical fiber section F4 that is optically coupled to output face 32 and input face 43. A phase modulator MA is arranged in optical fiber section F4. A detector DA is optically coupled to beamsplitter output face 43 via an optical fiber section F5. An optical telescope 50A is optically coupled to output face 43 of beamsplitter 40 via an optical fiber section F6. Laser unit 12 and phase modulator MA are operably coupled to controller CA.

Classical optics communications layer 6A includes an optical synchronization unit 110A and a beacon unit 120A each operably coupled to controller CA and that include respective telescopes 114A and 124A.

RF communication layer 8A includes an RF transceiver 130A operably coupled to controller CA. RF transceiver 130 includes an antenna 132A.

Controller CA includes a key bank 180 that stores classical and/or quantum keys that are either generated by ALICE and BOB, and/or that are pre-loaded.

### BOB

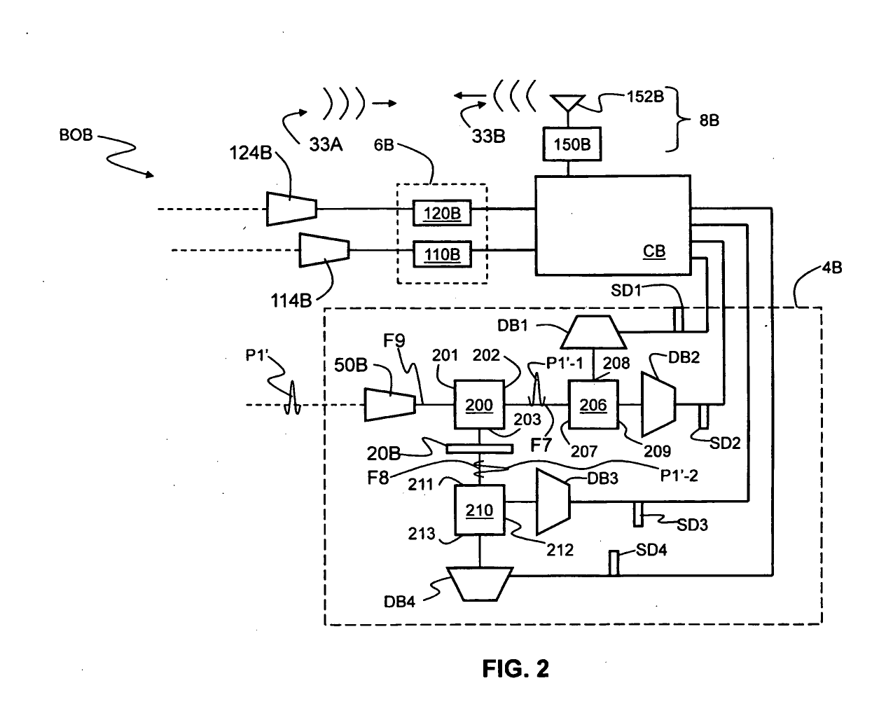

FIG. 2 is a schematic diagram of an example embodiment of a QKD station BOB suitable for use in combination with QKD station ALICE described immediately above and shown in FIG. 1. BOB also includes a quantum optics communication layer 4B, a classical optics communication layer 6B, and a RF communications layer 8B, all operably coupled to a controller CB and to the corresponding layers at ALICE, as described below. Quantum optics communication layers 4A and 4B constitute a quantum channel. Classical optics communication layers 6A and 6B constitute a synchronization channel and a beacon channel. RF communication layers 8A and 8B constitute an RF channel.

Quantum optics communications layer 4B includes a 50/50 beamsplitter 200 that has an input face 201 and two output faces 202 and 203. Quantum optics layer also includes two polarizing beamsplitter 206 and 210. Beamsplitter 206 has an input face 207 and two output faces 208 and 209. Beamsplitter 210 has an input face 211 and two output faces 212 and 213.

Beamsplitter 200 is optically coupled to beamsplitter 206 via an optical fiber section F7 optically coupled to output face 202 and input face 207. Beamsplitter 200 is also optically coupled to beamsplitter 210 via an optical fiber section F8 optically coupled to output face 203 and input face 211. A half-wave plate 20B is arranged in optical fiber section F8. An optical telescope 50B is optically coupled to input face 201 of beamsplitter 200 via an optical fiber section F9.

Quantum optics communications layer 4B also includes a first set of SPDs DB1 and DB2 optically coupled to beamsplitter 206 at output faces 208 and 209, respectively. Likewise, a second set of SPDs DB3 and DB4 are optically coupled to beamsplitter 210 at output faces 212 and 213, respectively. Each SPD is operably coupled to controller CB.

Classical optics communications layer 6B includes an optical synchronization unit 110B and a beacon unit 120B each operably coupled to controller CB and that include respective telescopes 114B and 124B.

RF communication layer 8B includes an RF transceiver 130B operably coupled to controller CB. RF transceiver 130 includes an antenna 132B.

A QKD system formed from ALICE and BOB of FIGS. 1 and 2 communicates over free-space. Quantum optics communication layers 4A and 4B are in optical communication via telescopes 50A and 50B. In an example embodiment, adaptive optics are employed in combination with telescopes 50A and/or 50B or other type of optical system to correct wavefront errors in the optical signals (pulses) that arise due to atmospheric distortion. Classical optics communication layers 6A and 6B are in optical communication via synchronization-unit telescopes 114A and 114B, and via beacon-unit telescopes 124A and 124B. The RF communications layers 8A and 8B are in RF communication via RF signals 33A transmitted by antenna 32A and received by antenna 32B, and via RF signals 33B transmitted by antenna 33B and received by antenna 32A.

### General QKD System Operation

In operation, the quantum optics communication layer 4A at ALICE operates by controller CA sending a signal S0 to laser 12 to cause the laser to emit a polarized optical pulse P0 that travels over optical fiber F2 to beamsplitter 30. Polarized optical pulse P0 enters beamsplitter 30 at input face 31. Beamsplitter 30 splits this pulse into two orthogonally polarized (say, horizontal (H) polarized and vertical (V) polarized) optical pulses P1 and P2 that exit the beamsplitter at output faces 32 and 33 and travel over optical fiber sections F4 and F3, respectively. Optical pulse P2 enters beamsplitter 40 at input face 42 and because of its polarization, is directed out of output face 44 and over to SPD DA1 via optical fiber section F5. The detection of optical pulse P2 is used for stabilizing ALICE.

Meantime, optical pulse P1 travels over optical fiber section F4 to input face 42 of beamsplitter 40. Controller CA sends a modulation signal SA to modulator MA that causes the modulator to impart to optical pulse P1 a modulation randomly selected from a set of basis phase modulations as the optical pulse passes through the modulator. This forms a modulated optical pulse P1′. Because of its polarization, modulated optical pulse P1′ is outputted from beamsplitter 40 at output face 42 and travels over optical fiber section F6 to telescope 50A. Optical pulse P1′ constitutes the quantum signal.

BOB's telescope 50B is in optical communication with telescope 50A and receives optical pulse P1′. Optical pulse P1′ is communicated to input face 201 of beamsplitter 200 via optical fiber section F9. Beamsplitter 200 splits modulated optical pulse P1′ into two optical pulses P1′-1 and P1′1-2, which exit the beamsplitter at respective output faces 202 and 203 and travel over respective optical fiber sections F7 and F8 to respective beamsplitters 206 and 210.

The role of classical optics layers 6A and 6B and RF communication layers 8A and 8B are discussed below in connection with the different example embodiments of the HAP-based QKD systems of the present invention.

Note that neither ALICE nor BOB include a Pockels cell. This is because it is undesirable to use a Pockels cell for quantum signal modulation due to the EMI it emits during modulation.

### HAP QKD System

In an example embodiment of the present invention, Alice and Bob are used to form a HAP-based QKD system. Several different example embodiments of a HAP-based QKD system are set forth below.

### FIRST EXAMPLE EMBODIMENT

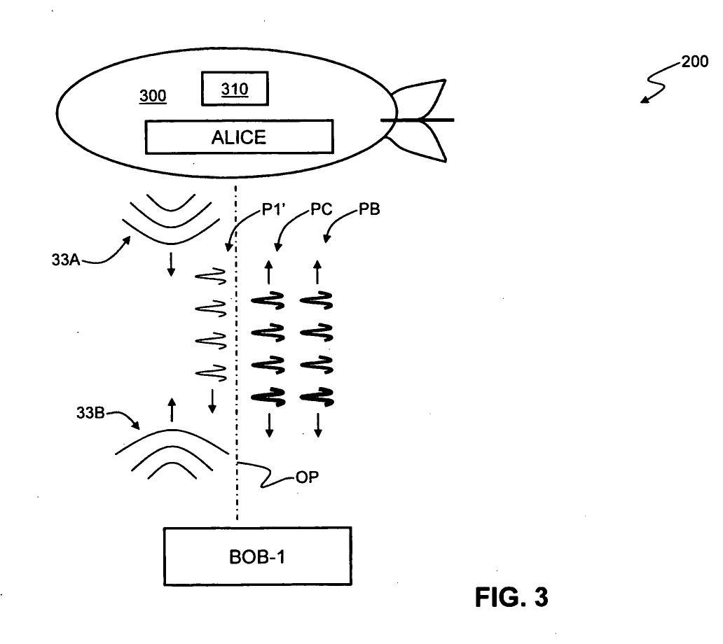

FIG. 3 is a schematic diagram of an example embodiment of a HAP-based QKD system 200 that employs a HAP 300, such as a zeppelin, as shown. HAP 300 includes a HAP controller 310 operably coupled to ALICE and that controls the position, speed and general operation of HAP 300. ALICE is carried by HAP 300, and BOB is ground-based. With reference to FIGS. 1 through 3, quantum optics layers 4A and 4B are in free-space optical communication via telescopes 50A and 50B at ALICE and BOB, respectively, as discussed above. In an example embodiment, the quantum channel is transmitted at ˜1550 nanometers. Although the task of single photon detection is challenging at 1550 nm, this wavelength region is attractive due to lower background flux from diffused sunlight and compatibility with standard telecommunications equipment.

The classical optics communication layers 6A and 6B are in optical communication via sync-unit telescopes 114A and 114B and beacon-unit telescopes 124A and 124B. In an example embodiment, the beacon and/or classical/synchronization channels have a wavelength in the range from 700 nm to 850 nm. Sync units 110A and 110B and their corresponding telescopes 114A and 114B provide synchronization between ALICE and BOB via optical synchronization signals PS so that the SPDs can be gated to the expected arrival time of the quantum signals P1′.

The distance between ALICE and BOB varies due to movement of HAP 300. Further, changes in the optical path can occur due to temperature and pressure variations in the atmosphere, which affect the index of refraction profile of the optical path OP between ALICE and BOB. Optical path variations change the expected arrival time of the quantum signals. Accordingly, optical beacon signals PB sent between beacon units 120A and 120B via their respective telescopes 124A and 124B are used to establish the optical path distance OPD_{AB} for the optical path OP between ALICE and BOB, e.g., for each quantum signal P1′ transmitted. Information about the optical path distance OPD_{AB} is provided to controller CA, which makes the corresponding adjustment to sync signals SO, SA, SD1, SD2, SD3, and SD4 to account for changes in the optical path distance OPD_{AB}.

In an example embodiment, sync units 110A and 110B and their corresponding telescopes 114A and 114B also serve as a classical communication channel between HAP and ground stations, e.g. for error correction and privacy amplification, via classical signals PC.

In an example embodiment, either ALICE or BOB can initiate a request for a QKD session. The request is sent through via the classical optics communication layers 6A and 6B, or via RF communication layers 8A and 8B. Once the request for QKD connection is confirmed by both stations, Alice starts a standard QKD process.

ALICE and BOB are in RF communication via RF communication layers 8A and 8B and RF signals 33A and 33B. The RF communication between ALICE and BOB allow for controllers CA and CB to communicate non-optically. This ability is particularly useful when the optical path OP between ALICE and BOB is obscured (e.g., by clouds) so that optical communication via the quantum optics layers 4A and 4B and/or via the classical optics communication layers 6A and 6B is difficult or impossible. RF communication via RF signals 33A and 33B is used, for example, to send instructions to the HAP controller 310 to change the position of HAP 300 so that optical communication can take place over optical path OP. In an example embodiment, RF signals 33A and 33B are also used to place ALICE and BOB in “standby” mode while communication over the classical and/or quantum optical communication channels is not available.

In an example embodiment, QKD system 200 runs the BB84 protocol with polarization encoding. ALICE has a delay line DL in optical fiber section F3 that makes the arms of her Mach-Zehnder interferometer equal. Phase modulator MA provides the needed polarization rotation. This design avoids the use of Pockels cells, which as mentioned above, are not secure because of a pronounced EMI signature during modulation.

### SECOND EXAMPLE EMBODIMENT

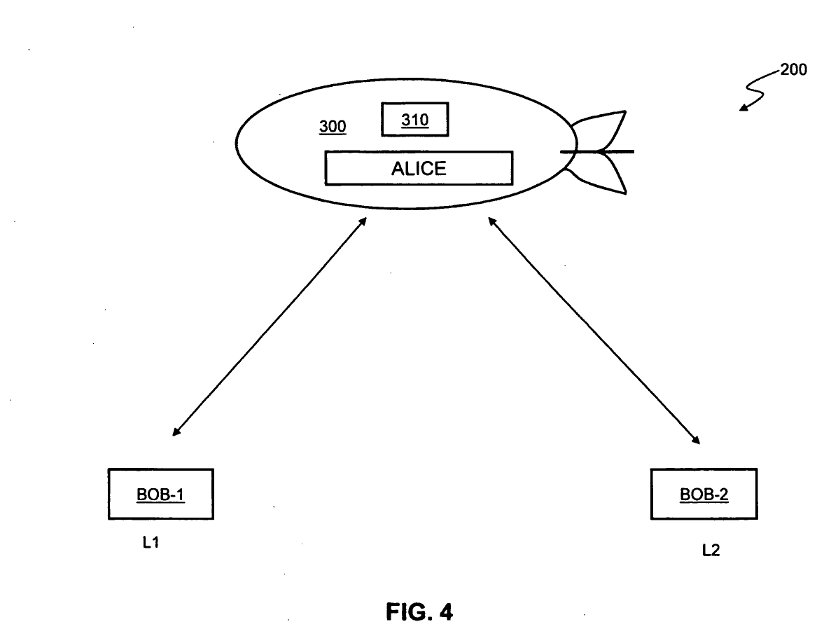

FIG. 4 is a schematic diagram illustrating a second example embodiment of a HAP-based QKD system 200 used to transfer quantum keys between QKD stations ALICE, BOB-1 and BOB-2, wherein BOB-1 and BOB-2 at different locations L1 and L2 and ALICE resides in HAP 300.

In one example, ALICE first establishes contact with BOB-1 and then ALICE and BOB-1 exchange quantum signals P1′ to establish a first quantum key. ALICE and BOB-2 then establish contact and exchange quantum signals to establish a second quantum key. ALICE then uses the second quantum key to encode and transmit the first quantum key to BOB-2 so that BOB-1 and BOB-2 now share the same first quantum key. BOB-1 and BOB-2 can then transmit encoded messages using such commonly shared quantum keys.

In another example, ALICE has quantum keys stored in key bank 180 and uses the first and second quantum keys to encode and transmit stored keys to BOB-1 and BOB-2, respectively. Again, this allows BOB-1 and BOB-2 to have a common set of secure keys.

Note that in the example embodiment of FIG. 4, HAP 300 need not be stationary. Thus, if BOB-1 and BOB-2 are too far apart for HAP 300 to communicate directly with them both at the same time, HAP 300 moves from the vicinity of location L1 to the vicinity of location L2 and then established contact and communicates with BOB-2.

### THIRD EXAMPLE EMBODIMENT

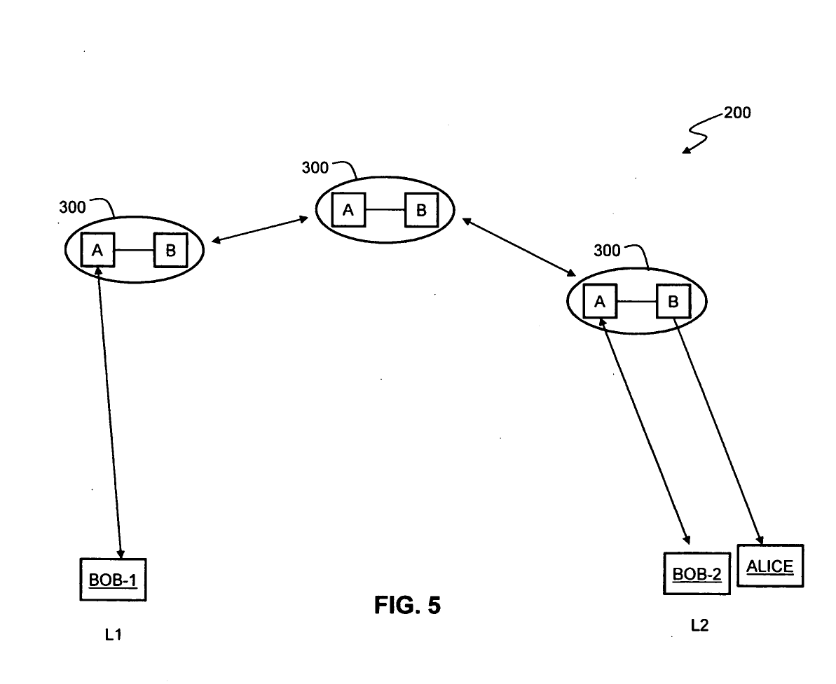

FIG. 5 is a schematic diagram of a third example embodiment of HAP-based QKD system 200 wherein HAP 300 includes both ALICE and BOB QKD stations. This allows for HAP 300 to serve as a platform for an ALICE-BOB relay station that provides for cascaded key transmission from BOB-1 at location L1 to BOB-2 at location L2. The ALICE-BOB QKD stations can also communication with an ALICE ground station, as shown.

### FOURTH EXAMPLE EMBODIMENT

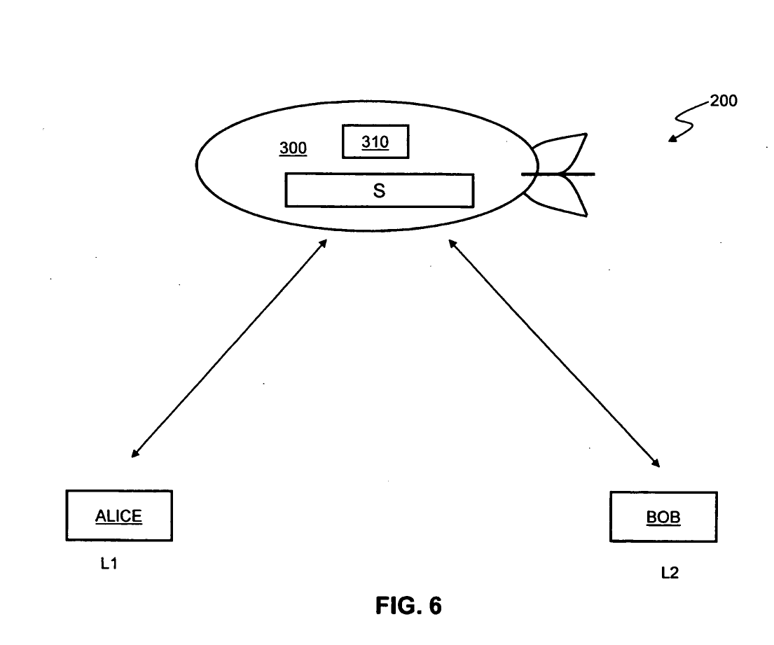

FIG. 6 is a schematic diagram of a fourth example embodiment of a HAP-based QKD system 200 that employs entangled photons to perform QKD. HAP 300 includes a source 300 of entangled photons, and ALICE and BOB have receivers suitable for entangled-photon QKD, such as disclosed, for example, in U.S. Pat. No. 6,028,935 to Rarity, which patent is incorporated by reference herein.

### FIFTH EXAMPLE EMBODIMENT

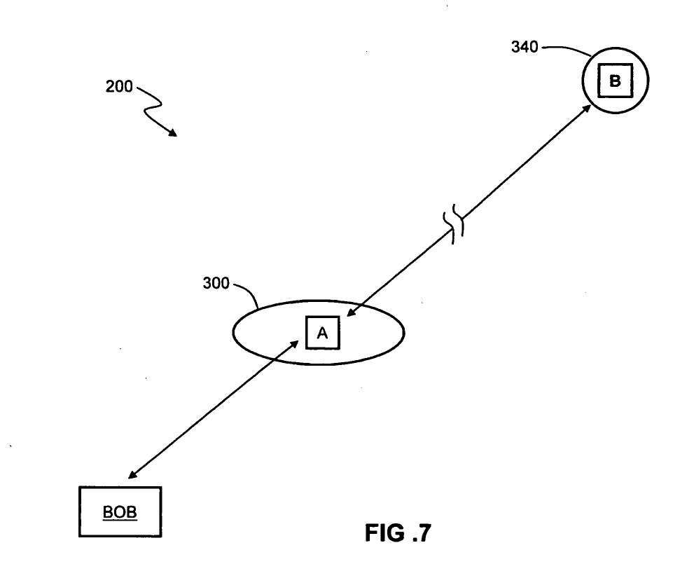

FIG. 7 is a schematic diagram of a fifth example embodiment of a HAP-based QKD system 200 that involves a spacecraft 340 that includes a QKD station BOB, as indicated by B. The QKD system 200 of FIG. 7 allows for a common key to be provided to a ground based QKD station and a space-based QKD station.

In this example embodiment, HAP 300 supports an ALICE, as indicated by A. A ground-based BOB-1 establishes contact with ALICE A in HAP 300 and establishes a first quantum key between them, as described above. ALICE A then uses this key to encrypt and send BOB-1 a key stored in key bank 180. Next, QKD station A exchanges quantum signals and establishes a second quantum key with QKD station B in spacecraft 340. QKD station A then uses this second key to encrypt and send B the same key provided to QKD station BOB-1. Thus, BOB-1 and space-based QKD station B share a common key for secure communication.

This example embodiment is particularly useful because HAP 300 can be located at an altitude that allows for an unobstructed optical path to spacecraft 340.

### Advantages

A HAP-based\QKD system offers several key advantages over other QKD systems, and particularly QKD systems that rely on space-based platforms such a spacecraft and satellites. HAPs are much less expense to deploy and maintain than spacecraft and satellites. If there is a doubt about the security of a HAP, it can be brought back to the ground, inspected and redeployed in short order. HAPs are also quite mobile and can be steered or piloted to different locations as needed. HAPs can also fly or be positioned at different altitudes and so can stay below clouds or and otherwise avoid obstructions in the free-space optical path that cause optical signal attenuation. HAPs also offer a broad signal coverage area. For example, a HAP positioned in the stratosphere at an altitude of ˜20 km ensures nearly a 1000 km simultaneous link distance between ground-based QKD stations, which provides secure data communication coverage over an area about the size of New England. Further, the mobility of the HAP extends this signal coverage area.

1. A quantum key distribution (QKD) system comprising:
a first ground-based QKD station;
a high-altitude platform (HAP) that supports a second QKD station so as to be in free-space communication with the first QKD station over an optical path via an optical quantum communication channel that carries quantum signals, an optical synchronization channel that carries synchronization signals, an optical beacon channel that carries beacon signals, and a radio-frequency (RF) channel that carries RF signals;
first and second single-photon detector (SPD) pairs in the second QKD station; and
wherein the beacon signals are used to detect changes in the optical path and correct the synchronization signals so as to gate the first and second SPD pairs to correspond to arrival times of the quantum signals at said first and second SPD pairs.

2. The system of claim 1, wherein the HAP includes a Zeppelin.

3. The system of claim 1, wherein the second QKD station is ALICE, and further including a third QKD BOB that is supported by the HAP and that is operably coupled with the second QKD station ALICE to form a QKD relay ALICE-BOB.

4. The system of claim 3, including two or more HAPS each having QKD relays ALICE-BOB, wherein the QKD relays are in free-space optical communication and are adapted to exchange quantum signals with each other.

5. The system of claim 4, including a second ground-based QKD station BOB or ALICE that is in operable communication with one of the QKD relays ALICE-BOB supported by one of the HAPS.

6. The system of claim 1, wherein neither the first nor the second QKD station include a Pockels cell for performing quantum signal modulation.

7. The system of claim 1, wherein the HAP is not in earth orbit.

8. The system of claim 7, further including:
a third QKD station supported by a spacecraft in earth orbit, wherein the third QKD station is in optical communication with the second QKD station in the HAP and is adapted to establish a common quantum key between the first ground-based QKD station and the third spacecraft-based QKD station.

9. A quantum key distribution (QKD) system comprising:
first and second ground-based QKD stations;
a high-altitude platform (HAP) having a source of first and second entangled photons and that is adapted to communicate the first and second entangled photons to the first and second QKD stations; and
wherein the first and second QKD stations are adapted to received and process the first and second entangled photons to establish a shared quantum key.
